(19) United States
(12) Patent Application Publication
(10) Pub. No.: US 2015/0324443 A1
(43) Pub. Date: Nov. 12, 2015

(54) STORAGE CLUSTERING SYSTEMS AND METHODS FOR PROVIDING ACCESS TO CLUSTERED STORAGE

(71) Applicant: Wistron Corp., New Taipei City (TW)

(72) Inventor: Chih-Ming CHEN, New Taipei City (TW)

(21) Appl. No.: 14/333,385

(22) Filed: Jul. 16, 2014

(30) Foreign Application Priority Data
May 9, 2014 (TW) 103116599

(51) Int. Cl. G06F 17/30

(52) U.S. Cl. CPC G06F 17/30598; G06F 17/30864; G06F 17/30336

(57) ABSTRACT

A storage clustering system comprises storage front-ends and clustering modules. At least one clustering module receives an access command from a client. When the access command instructs that a data item be stored, a clustering module invokes at least one computing module to compute at least one derivative value of the data item, and at least one clustering module stores, based on an index, the derivative value or at least part of the data item through a storage front-end, and accordingly updates an instance of metadata. When the access command instructs that a data item be fetched, a clustering module examines the metadata to select a storage front-end, through which a clustering module fetches the data item. When the storage front-end returns a derivative value instead, the fetching clustering module examines the index according to the derivative value to synthesize the data item for the client.

### CROSS-REFERENCE TO RELATED APPLICATIONS

This non-provisional application claims priority under 35 U.S.C. §119(a) on Patent Application No. 103116599 filed in Taiwan, R.O.C. on May 9, 2014, the entire contents of which are hereby incorporated by reference.

### TECHNICAL FIELD

The present invention relates to storage clustering, particularly to performance considerations and data de-duplication in clustered storage.

### BACKGROUND

One may generally “scale up” but not “scale out” conventional storage architecture. That is, assuming uniform specification and a constant number of host machines in the architecture, only by installing or replacing more hard disk drives can one acquire more storage space. Scaling up, therefore, is not sustainable and brings about no performance increase. When scaling up, it is quite time-consuming for data to migrate from original, smaller drives to newly purchased, larger drives. To make matters worse, a drive's cost is often exponential to its capacity.

The above problems can be partially solved by clustering the storage and managing it by nodes. In an exemplary SCSI (Small Computer System Interface) storage cluster, however, the clustering and the granting of access occur in the logical volume management (LVM) layer, behind SCSI targets. Clients must be able to individually identify these targets, each of which is capable of controlling a mere eight to sixteen SCSI devices. Performance deteriorates beyond imagination if distributed lock management (DLM) is also applied to the targets.

### SUMMARY

In light of the above, the present invention discloses storage clustering systems respectively responding to read/fetch and write/store commands from clients, and methods for providing access to clustered storage.

A storage clustering system provided by this disclosure comprises a plurality of storage front-ends and a plurality of clustering modules. At least one of the clustering modules is configured to receive from a client an access command instructing that a data item be fetched. One of the clustering modules is configured to examine an instance of metadata to select one of the storage front-ends. One of the clustering modules (the “fetching” module) is configured to fetch the data item through the selected storage front-end. When the selected storage front-end returns the data item, the fetching module returns the data item to the client. When the selected storage front-end returns a first derivative value of the data item, the fetching module examines an index according to the first derivative value so as to synthesize the data item for the client.

In a method for providing access to clustered storage, as provided by this disclosure, an access command instructing that a data item be fetched is received from a client. An instance of metadata is examined to select a storage front-end corresponding to the data item. The data item is then fetched through the storage front-end. During said fetching, the data item is returned to the client when the storage front-end returns the data item, or synthesized for the client by examining an index according to a first derivative value of the data item when the storage front-end returns the first derivative value.

Another storage clustering system provided by this disclosure comprises a plurality of storage front-ends, a plurality of computing modules, and a plurality of clustering modules. At least one of the clustering modules is configured to receive from a client an access command instructing that a data item be stored. One of the clustering modules is configured to invoke at least one of the computing modules to compute at least one derivative value of the data item. At least one of the clustering modules (the “storing” module) is configured to store the data item through one of the storage front-ends and update an instance of metadata accordingly. When the derivative value is not in an index, the storing module stores at least part of the data item. When the derivative value exists in the index, the storing module stores the derivative value instead.

In another method for providing access to clustered storage, as provided by this disclosure, an access command instructing that a data item be stored is received from a client. At least one derivative value of the data item is computed, and the data item is stored through a storage front-end, an instance of metadata updated accordingly. When the derivative value is not in an index, at least part of the data item is stored. When the derivative value exists in the index, the derivative value is stored instead.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a block diagram of a storage clustering system, in accordance with an embodiment of the present invention.

FIGS. 2 and 3 are flowcharts of methods for providing access to clustered storage, in accordance with various embodiments of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

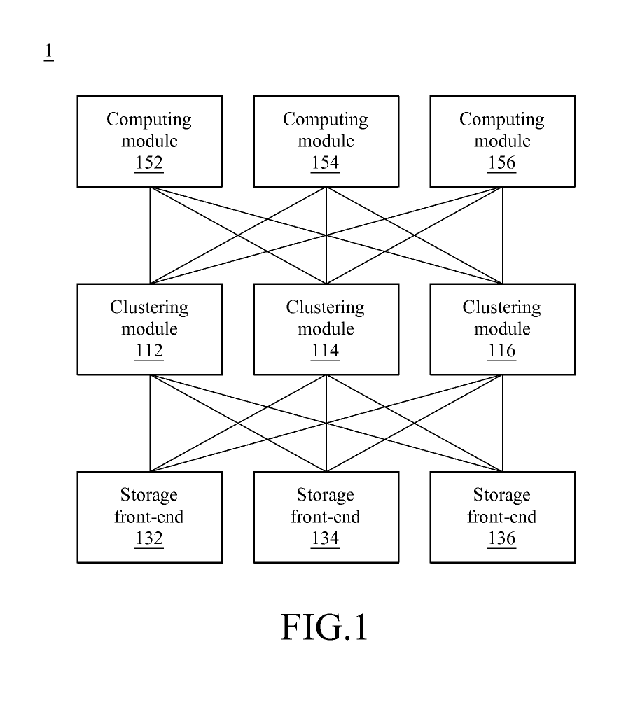

Please refer to FIG. 1. As shown in the block diagram, a storage clustering system 1 comprises clustering modules 112, 114, and 116, respectively corresponding storage front-ends 132, 134, and 136, and respectively corresponding computing modules 152, 154, and 156. A storage cluster generally must be quorate to function. Here the three clustering modules 112, 114, and 116 signify that the storage clustering system 1 is distributed on three (physical or virtual) host machines, the machine where the clustering module 112 resides comprising the storage front-end 132 and the computing module 152, and so forth. In another embodiment, the clustering module 112 may not correspond to only the storage front-end 132 and the computing module 152; that is, there may be more storage front-ends or computing modules on the machine where the clustering module 112 resides. Though not explicitly depicted so, the clustering modules 112, 114, and 116 are coupled with one another. In practice, as services on their respective machines, any of the storage front-ends 132, 134, and 136 may be accessed by any of the clustering modules 112, 114, and 116, and any of the computing modules 152, 154, and 156 may be invoked by any of the clustering modules 112, 114, and 116.

For the clustering modules 112, 114, and 116, each of the storage front-ends 132, 134, and 136 hides the hardware details behind it and provides a file system or logical storage space. Suppose that underlying the storage clustering system 1 are SCSI devices. The storage front-ends 132, 134, and 136 are then SCSI targets that may typically be implemented with tgtd. Of course the storage front-ends 132, 134, and 136 may as well be based on the derivative iSCSI (Internet SCSI) or its Ethernet counterpart, HyperSCSI; SAS (Serial Attached SCSI) or its parallel counterpart, Parallel SCSI; InfiniBand; Fibre Channel (FC) or its Ethernet or Internet Protocol variant (FC over Ethernet or FC over IP); or ATA (Advanced Technology Attachment) over Ethernet.

The clustering modules 112, 114, and 116 and the computing modules 152, 154, and 156 form a distributed computing platform. If Apache Storm is applied, then each of the clustering modules 112, 114, and 116 is a master node for initiating and dispensing a task or computation to at least one of the computing modules 152, 154, and 156, and any of the computing modules 152, 154, and 156 can further divide and dispense the task assigned thereto to one another. The dispensations recur until the task is done.

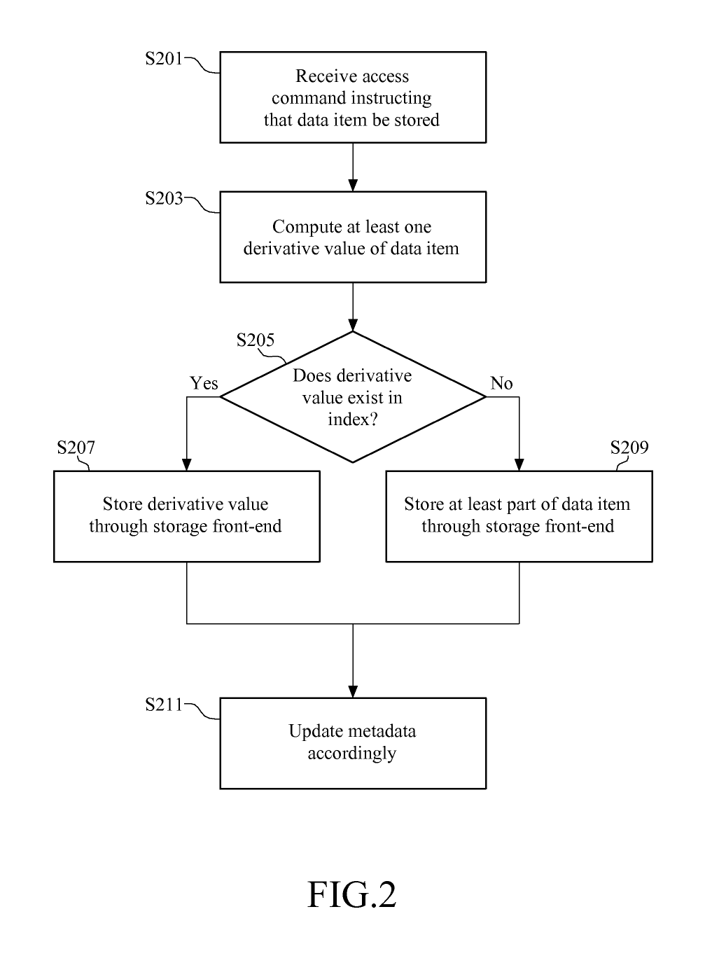

Please refer to FIG. 2 with regard to FIG. 1. As shown in this flowchart, in step S201, at least one of the clustering modules 112, 114, and 116 receives from a client an access command instructing that a data item be stored. The client may send the access command to several clustering modules or to a fixed or random one, e.g. the clustering module 112. Depending on the environment settings of the storage clustering system 1, the clustering module 112 may execute step S203 and process the access command by itself, or refer all transactions with the client to another clustering module in charge, e.g. 114. In particular, the clustering module 112 may notify the client with a proxy end-pointer that it has been referred to the clustering module 114. The client thereafter deals only with the clustering module 114, at least during the current storing session. In another embodiment, the clustering module 114 may assume the identity of the clustering module 112, or the storage clustering system 1 further comprises a common front-end of the clustering modules 112, 114, and 116, hiding said referral from the client.

Suppose that the access command is processed by the receiving clustering module 112. In step S203, the clustering module 112 invokes at least one of the computing modules 152, 154, and 156 to compute at least one derivative value of the data item. Please note that the clustering module 112 may, but not necessarily, prefer to initiate the computation with the computing module 152, which corresponds to or is on the same host machine as the clustering module 112. The derivative value usually refers to the output of a hash function applied to the data item. Step S203 is the first stage of the data de-duplication of the present invention. Generally speaking, it is easier to process the derivative, hash, or digest value(s) of the data item than to process the data item itself. Dispensation of the task or computation may take place at the clustering module 112 or any invoked computing module. The data item may be segmented, and an invoked computing module may be responsible for the derivative value of one of the segments. In another embodiment, suppose that the clustering module 112 invokes the computing module 152, which in turn invokes the computing module 154. The computing module 152 may be responsible for a rough or fuzzy digest of the data item; that is, the computing module 152 gives a general description of the features or characteristics of the data item. On the other hand, the computing module 154 is in charge of a detailed, distinct description. Said “at least one” derivative value in step S203 may therefore be arbitrarily many or few and be in parallel and/or recursively computed.

Recall the example above where the computing modules 152 and 154 are invoked. In step S205, the computing module 152 examines an index of the storage clustering system 1 to determine whether the computed fuzzy digest has been recorded therein. The existence of the fuzzy digest in the index suggests that the storage clustering system 1 once processed a data item similar to the one at hand, and the index is able to indirectly indicate where through the storage front-ends 132, 134, and 136 the data bits corresponding to the fuzzy digest are stored and need not be written again. Only the fuzzy digest is stored once for recording purposes in step S207 as a result. When the fuzzy digest is not found in the index, obviously at least part of the data item, to which the fuzzy digest corresponds, needs to be stored in step S209. An update on the index ensues in one embodiment; that is, an entry associated with the fuzzy digest is added to the index. In one embodiment, the index is only updated when the fuzzy digest is encountered beyond a certain frequency or for a certain number of times, thus justifying data de-duplication. The operation of the computing module 154 after it computes the distinct digest is similar to the above and includes another selective update on the index. The existence of the distinct digest in the index suggests that the storage clustering system 1 once processed a data item similar to the one at hand, and storing the distinct digest once suffices for the moment.

The index is shared amongst the clustering modules 112, 114, and 116 and may be a lookup table regarding the contents of data items. In one embodiment, each of the clustering modules 112, 114, and 116 has a copy of the index, and synchronizes or maintains the index with one another incrementally or by delta updates. The synchronization may be one-to-many or may be recursively propagated, similar to how the computing modules 152, 154, and 156 work.

In short, the data item, as a combination of original bits and the derivative value(s), is stored through a storage front-end by at least one clustering module in steps S205 to S209. The combination is termed a “first derivative value” when at least one derivative value is stored, and a “second derivative value” is any of the rough, detailed, or segmental derivative value(s) included in the first derivative value. An arbitrary clustering module carries out the act of storage. For example, the computing module 152 may cause its corresponding clustering module 112 to select a storage front-end (e.g. 132) for storing the fuzzy digest or part of the data item, and the computing module 154 causes its corresponding clustering module 114 to write through the same storage front-end. Each of the storage front-ends 132, 134, and 136 manages its own corresponding file system or logical storage space. All this management information is aggregated as the metadata of the storage clustering system 1 and shared amongst the clustering modules 112, 114, and 116. When a clustering module stores a data item, it also updates the metadata accordingly in step S211. In one embodiment, each of the clustering modules 112, 114, and 116 has a copy of the metadata and maintains the metadata incrementally as it does the index.

In attempting de-duplication, steps S203 to S209 may be regarded as model building in machine learning. Specifically, the storage clustering system 1 may perform statistical classification on the distributed computing platform formed by the clustering modules 112, 114, and 116 and the computing modules 152, 154, and 156. Examples of statistical classification are perceptron, linear classification (which may be confidence-weighted), and passive-aggressive algorithms.

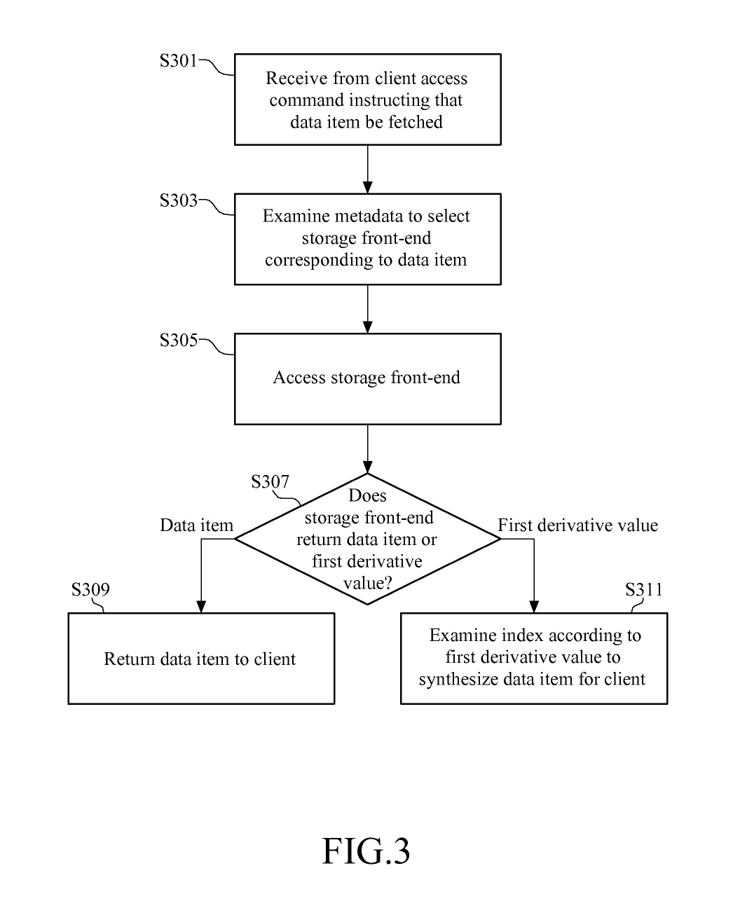

Please refer to FIG. 3 with regard to FIGS. 1 and 2. In this flowchart, step S301 is similar to step S201, the only difference being that here the access command instructs instead that a data item be fetched. Suppose that the access command is received by the clustering module 112. The clustering module 112 may process the access command by itself, refer all transactions with the client straight to another clustering module, or determine whether to refer after executing step S303. Suppose that the client is referred directly to the clustering module 114. In step S303, the clustering module 114 examines the metadata to be informed of through which of the storage front-ends 132, 134, and 136 should the data item be fetched. Suppose that the storage front-end 136 is selected. The clustering module 114 simply accesses the storage front-end 136 in step S305 in one embodiment. In another, the clustering module 116, which corresponds to the storage front-end 136, is preferred for the fetch. In any case, the clustering module fetching the data item is generally also responsible for returning it to the client.

Suppose that step S305 is executed by the clustering module 114. In response to the access by the clustering module 114, the storage front-end 136 returns the data item itself or the first derivative value in step S307. When the data item is returned, the clustering module 114 returns it to the client in step S309. When the first derivative value is returned, the clustering module 114 examines the index iteratively or recursively depending on the structure of the first derivative value (please see the above description of step S203), so as to read in the data bits represented by the first or second derivative values, and thereby synthesize or restore the data item for returning to the client.

The present invention emphasizes the coordination between clustering modules of the same design. In practice, therefore, only one template of the clustering module is required to deploy a storage clustering system. For example, a content delivery apparatus may be configured to equip a host machine with a clustering module, a storage front-end, and a computing module. The content delivery apparatus may provide the machine with the installer or patch of these modules, or it may push a configuration of operating system to the machine. The content delivery apparatus may as well be simply a file server hosting the program code implementing at least part of the methods for providing access to clustered storage, and a management console of the storage clustering system downloads the program code and distributes it to the managed hosts.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. A storage clustering system comprising:
a plurality of storage front-ends; and
a plurality of clustering modules;
wherein at least one of the clustering modules is configured to receive an access command from a client, the access command instructing that a data item be fetched;
wherein one of the clustering modules is configured to examine an instance of metadata to select one of the storage front-ends;
wherein one of the clustering modules is configured to fetch the data item through the selected storage front-end;
wherein to fetch the data item comprises:
when the selected storage front-end returns a first derivative value of the data item, the clustering module configured to fetch the data item examines an index according to the first derivative value so as to synthesize the data item for the client; and
when the selected storage front-end returns the data item, the clustering module configured to fetch the data item returns the data item to the client.

2. The storage clustering system of claim 1, wherein each of the clustering modules is further configured to maintain the metadata or the index toward another of the clustering modules.

3. The storage clustering system of claim 1, wherein the first derivative value comprises part of the data item or at least one second derivative value.

4. The storage clustering system of claim 3, wherein the index is examined recursively by the clustering module configured to fetch the data item.

5. The storage clustering system of claim 3, wherein when the first derivative value comprises a plurality of second derivative values, one of the second derivative values corresponds to more of the data item than another of the second derivative values.

6. The storage clustering system of claim 1, wherein each of the clustering modules corresponds to at least one of the storage front-ends.

7. A method for providing access to clustered storage, comprising:
receiving an access command from a client, the access command instructing that a data item be fetched;
examining an instance of metadata to select a storage front-end corresponding to the data item; and
fetching the data item through the storage front-end;
wherein fetching the data item comprises:
examining an index according to a first derivative value of the data item when the storage front-end returns the first derivative value, so as to synthesize the data item for the client; and
returning the data item to the client when the storage front-end returns the data item.

8. The method of claim 7, further comprising maintaining the metadata or the index.

9. The method of claim 7, wherein the first derivative value comprises part of the data item or at least one second derivative value.

10. The method of claim 9, wherein the index is examined recursively.

11. The method of claim 9, wherein when the first derivative value comprises a plurality of second derivative values, one of the second derivative values corresponds to more of the data item than another of the second derivative values.

12. A storage clustering system comprising:
a plurality of storage front-ends;
a plurality of computing modules; and
a plurality of clustering modules;
wherein at least one of the clustering modules is configured to receive an access command from a client, the access command instructing that a data item be stored;
wherein one of the clustering modules is configured to invoke at least one of the computing modules to compute at least one derivative value of the data item;
wherein at least one of the clustering modules is configured to store the data item through one of the storage front-ends and update an instance of metadata accordingly;
wherein to store the data item comprises:
when the derivative value exists in an index, the clustering module configured to store the data item stores the derivative value; and
when the derivative value does not exist in the index, the clustering module configured to store the data item stores at least part of the data item.

13. The storage clustering system of claim 12, wherein each of the clustering modules is further configured to maintain the metadata or the index toward another of the clustering modules.

14. The storage clustering system of claim 12, wherein each of the computing modules, when invoked, performs at least part of a computation and selectively invokes another of the computing modules to perform part of the computation.

15. The storage clustering system of claim 12, wherein when the at least one derivative value is a plurality of derivative values, one of the derivative values corresponds to more of the data item than another of the derivative values.

16. The storage clustering system of claim 12, wherein to store the data item further comprises:
when the derivative value does not exist in the index, the clustering module configured to store the data item selectively updates the index accordingly.

17. The storage clustering system of claim 12, wherein each of the clustering modules corresponds to at least one of the storage front-ends and at least one of the computing modules.

18. A method for providing access to clustered storage, comprising:
receiving an access command from a client, the access command instructing that a data item be stored;
computing at least one derivative value of the data item; and
storing the data item through a storage front-end and updating an instance of metadata accordingly;
wherein storing the data item comprises:
storing the derivative value when the derivative value exists in an index; and
storing at least part of the data item when the derivative value does not exist in the index.

19. The method of claim 18, further comprising maintaining the metadata or the index.

20. The method of claim 18, wherein when the at least one derivative value is a plurality of derivative values, the derivative values are computed recursively.

21. The method of claim 18, wherein when the at least one derivative value is a plurality of derivative values, one of the derivative values corresponds to more of the data item than another of the derivative values.

22. The method of claim 18, wherein storing the data item further comprises:
selectively updating the index accordingly when the derivative value does not exist in the index.
